(19) United States
(12) Patent Application Publication
(10) Pub. No.: US 2011/0161135 A1
(43) Pub. Date: Jun. 30, 2011

(54) METHOD AND SYSTEMS FOR COLLATERAL PROCESSING

(75) Inventors: Harold Lee, Holly Springs, NC (US); Alexander Chapman, Holly Springs, NC (US)

(73) Assignee: Teradata US, Inc., Miamisburg, OH (US)

(21) Appl. No.: 12/650,216

(22) Filed: Dec. 30, 2009

(51) Int. Cl. G06Q 30/00; G06Q 10/00

(52) U.S. Cl. 705/7.29

(57) ABSTRACT

Methods and systems for processing collaterals are described. A method may include receiving qualifying criteria from a client. The qualifying criteria may define assignments of one or more collaterals. An assignment tool may be generated based on the qualifying criteria. The assignment tool may include a number of stored attributes and one or more interaction attribute to be determined based on a customer interaction. The assignment tool may be used to assign a collateral to a customer. Additional methods and systems are disclosed.

### BACKGROUND

An effective Customer Relationship Management (CRM) may help enterprises to really know their customers. Having a better understanding of their customers, enterprises may quickly resolve challenges such as customer value, acquisition, growth, and retention while enhancing their return on investment (ROI). In particular, the growth of the Internet, mobile sales channels, and social networking, has made recognizing customers across multiple touch points a challenge.

Robust database engines may facilitate more efficient targeted advertising and more relevant conversations with customers, which may lead to more profitable, satisfying and longer-lasting relationships. Such databases may make harnessing of advanced analytical and marketing communications more feasible.

### BRIEF DESCRIPTION OF THE DRAWINGS

Some embodiments of the disclosed technology are illustrated by way of example and not limitation in the figures of the accompanying drawings in which:

FIG. 1 is a high level diagram illustrating processing of collateral assignments, according to various embodiments;

FIG. 2 is a block diagram illustrating stages involved in processing of collateral assignments, according to various embodiments;

FIG. 3 is a block diagram illustrating a collateral processing system, according to various embodiments;

FIG. 4 a flow diagram illustrating a method of processing of collaterals, according to various embodiments;

FIG. 5 is a flow diagram illustrating an interaction service for servicing an inbound campaign, according to various embodiments;

FIG. 6 is a block diagram illustrating a decision tree used for servicing an inbound campaign, according to various embodiments

FIG. 7 is block diagram illustrating a fact table used for servicing an inbound campaign, according to various embodiments; and

FIG. 8 is a block diagram of a machine, according to various embodiments.

### DETAILED DESCRIPTION

Example methods and systems for processing of collaterals will now be described. In the following description, numerous examples having example-specific details are set forth to provide an understanding of example embodiments. It will be evident, however, to one of ordinary skill in the art, after reading this disclosure, that the present examples may be practiced without these example-specific details, and/or with different combinations of the details than are given here. Thus, specific embodiments of the invention are given for the purpose of simplified explanation, and not limitation.

Some embodiments described herein include receiving qualifying criteria from a client. The qualifying criteria may define assignments of one or more collaterals. An assignment tool may be generated based on the qualifying criteria. The assignment tool may include a number of stored attributes and one or more interaction attributes to be determined based on a customer interaction. The assignment tool may be used to assign collateral to a customer.

The client may comprise an agent of an entity such as a business entity (e.g., a corporation, a firm, an online business, and the like). The agent may, for example, be a marketing manager of the business entity who is a decision maker on marketing campaigns (e.g., inbound and outbound marketing campaigns) or a clerk responsible for an informational campaign (e.g., disseminating informational material). The outbound campaign may comprise broadcasting (e.g., via mail, fax, email, phone call, text messaging, Website, and the like.) collaterals to one or more customers of the business entity.

The collaterals may comprise promotional offers (e.g., free upgrades, limited free service, discounts on prices of items or services, free devices such as cell phones or memory sticks and so forth), advertisement materials (e.g., brochures, catalogs, flyers, and so on), or informational materials (e.g., letters and notifications informing of a contract change, a new price, a termination of a warranty) and the like. The agent may use an application such as a relation manager software (e.g., a relation manager application provided by TERADATA Corporation of Miamisburg, Ohio, such as TERADAT Relation Manager (TRM)) to provide qualifying criteria.

The qualifying criteria (hereinafter “criteria”) may define assignments of a number of collaterals to one or more campaigns. In other words, the qualifying criteria may define which campaigns and under what conditions would be qualified to be assigned certain collaterals. More detailed description of the collateral processing will be given by the embodiments described herein.

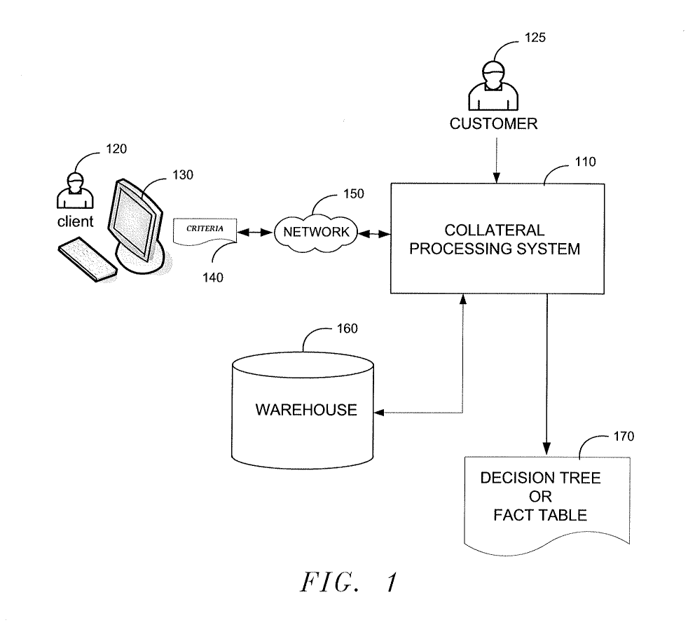

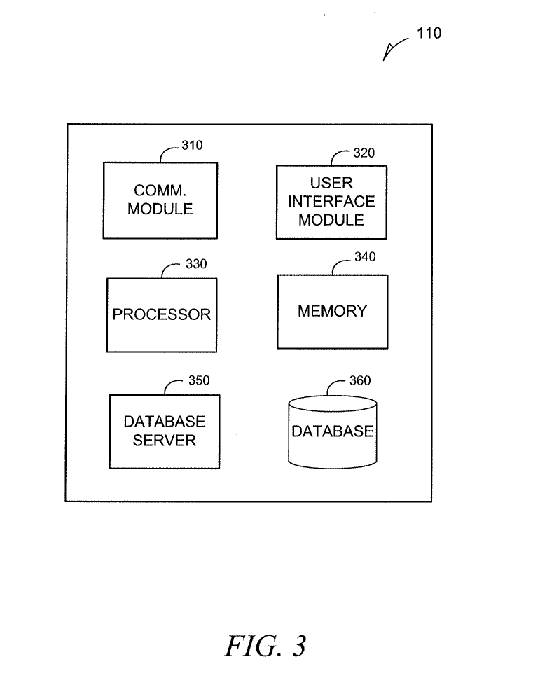

In an embodiment, the disclosed methods and systems may be used in the form of one or more Web applications provided to a user (e.g., the client or the customer) via Web interfaces. The Web applications may be supported by a system 300 shown in FIG. 3 and described below. In other embodiments, the disclosed methods may be provided as one or more client applications to be installed and executed on a client machine such as the client machine 130 shown in FIG. 1 and used by the customer 125 shown in FIG. 1.

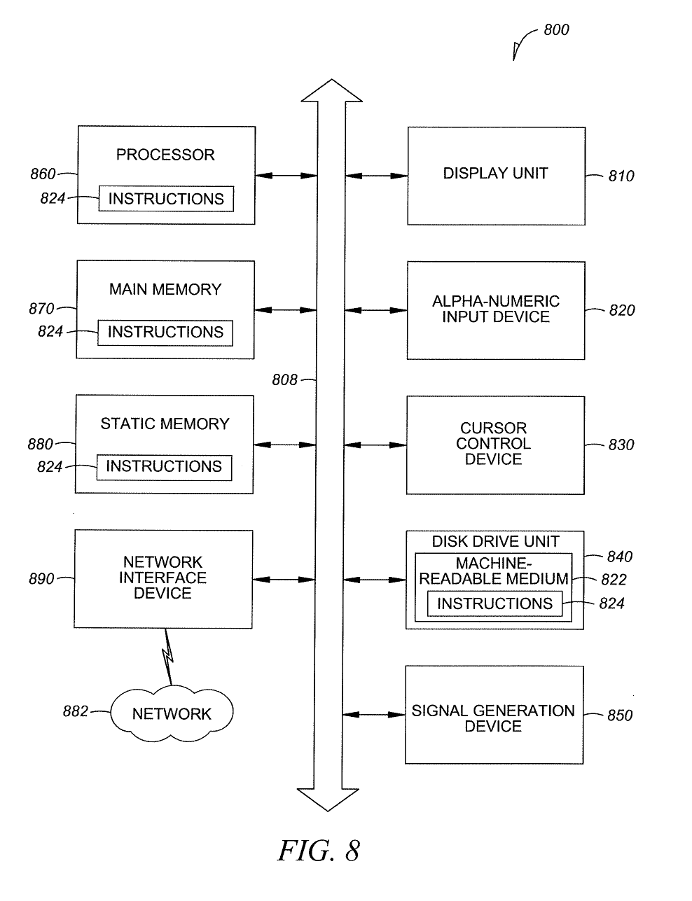

FIG. 1 is a high level diagram illustrating processing of collateral assignments, according to various embodiments. The client 120, using the client machine 130 (e.g., a machine 800 shown in FIG. 8, such as a laptop, a desktop, or a tablet computer, a cell phone, a personal digital assistant (PDA), and the like) may be coupled to the collateral processing system 110 via a network 150. In an embodiment, the client 120 may enter a Website supported by the collateral processing system 110 to provide criteria 140, for example, in the form of defined assignment rules for assigning a number of collaterals to one or more campaigns of a business entity. The campaigns may comprise advertising campaigns, informational campaigns, service campaigns (e.g., campaigns involving presenting company's products and services to a potential customer such as a customer of a competitor), an up-sell campaign (e.g., selling upgrades to existing customers), cross-sell campaigns (e.g., selling other products and services to an existing customer).

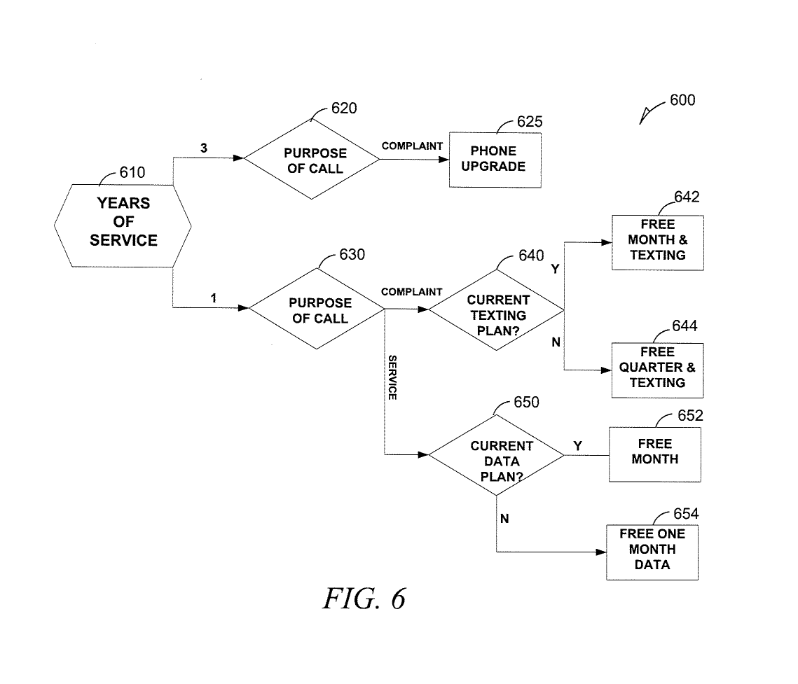

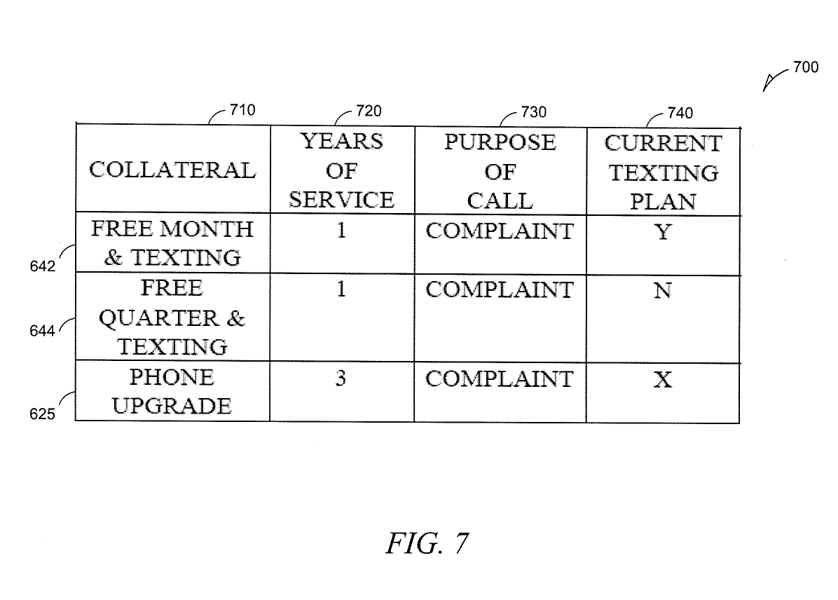

The rules may specify under what condition a collateral will be assigned to a campaign. The collateral processing system 110 may receive the defined assignment rules and generate an assignment tool 170 such as a decision tree (e.g., a decision tree 600 shown in FIG. 6) or a fact table 700 shown in FIG. 7) based on the defined assignment rules. The assignment tool 170 may involve stored attributes (warehouse attributes, e.g., length of service, the list of services or products purchased by a customer 125 of the business entity, and other historical data corresponding to the customer 125) retained in the warehouse 160 (e.g., a database 360 shown in FIG. 3). The assignment tool 170 may further involve interaction attributes which are predicted to be received during the customer 125's interaction with the business entity.

The customer 125's interaction with a business entity may comprise, making a phone call, staring a chat session on a Website associated with the business entity, starting a session on a kiosk provided by the business entity, providing a comment in an online forum associated with a social network, sending an email or a text message, and the like. Customer interactions may be recorded and stored in the warehouse 160. The collateral processing system 110 may derive values for the interaction attributes, as discussed in more detail herein, and process an assignment of collateral to the customer 125. The collateral processing system 110 may employ the assignment tool 170 to automatically assign collateral to the customer 125. The collateral may be offered to the customer 125 before the customer ends the interaction.

This is particularly beneficial that the collateral processing system 110 can process the collateral assignment in a short time (e.g. milliseconds) and allow offering of the collateral to the customer in a real-time manner (e.g., during the same interaction session with the customer). Traditional systems do not use a prepared decision tree or a fact table to make real time decision on offering one or more collaterals to an interacting customer such as the customer 125. Traditional systems, instead, may spend long amounts of time dealing with huge volumes of warehouse data and join many different sources of data such as customer transaction histories.

In embodiments, customer interaction sessions may be recorded and more interaction attributes may be derived from the recorded interactions and stored in the warehouse 160. The derived interaction attributes may be used in future assignment tool developments such as the creation of new fact tables and decision trees.

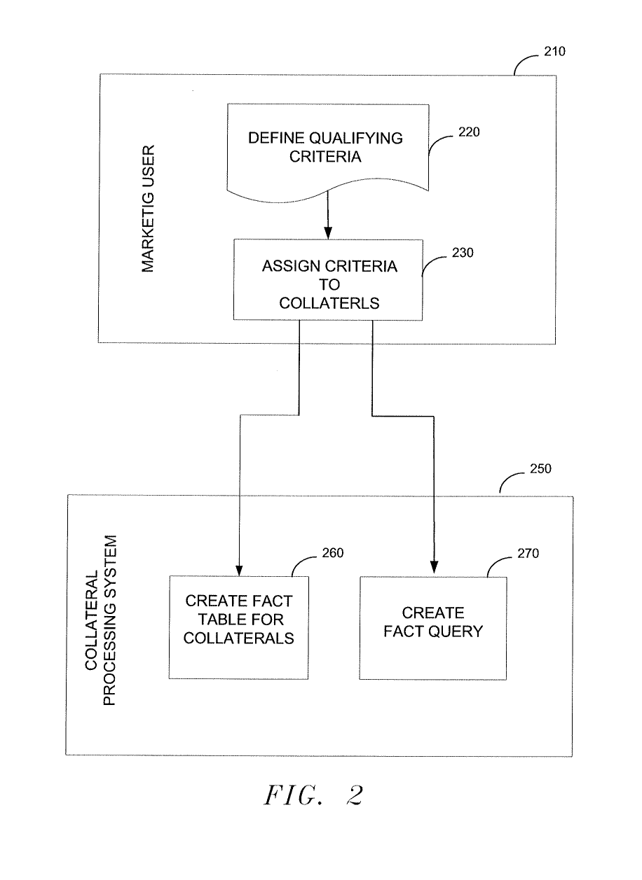

FIG. 2 is a block diagram illustrating stages involved in processing of collateral assignments, according to various embodiments. At stage 210, the client 120 of FIG. 1 (e.g., a marketing user of a business entity) may, at block 220, enter a Website or use a client application stored in the client machine 130 of FIG. 1 to define criteria 140 of FIG. 1. The criteria 140 may comprise qualifying criteria such as a list of campaigns (e.g., campaigns 1-10), the purpose of each campaign (e.g., advertisement, informational, service, up-sell, cross-sell, and so on), targets (e.g., existing customers, potential customers, and so forth), list of collaterals, description of collaterals, and the like.

The client 120 may, at block 230, provide assignments of collaterals from a list of collaterals to various campaigns. For example, the client may specify that collaterals number 1-5 be assigned to a particular advertising campaign and collaterals 6-10 be considered for an informational campaign. The client 120 may further provide specific assignment rules for assigning one or more collaterals to a campaign. For instance, for a case where the business entity is a wireless service provider, the assignment rules may be used to assign a collateral such as a free month of service to an up-sell campaign. The assignment rule, for example, may specify that the free month of service be offered to a customer that calls to make a complaint and is currently signed up for text messaging or data plan (see decision tree 600 shown in FIG. 6).

At stage 250, the collateral processing system 110 may use the assignment rules to generate the assignment tool 170 of FIG. 1. In an embodiment, the collateral processing system 110 may, at block 260, create a number of fact tables, such as the fact table 700 shown in FIG. 7, for the collaterals listed for various campaigns. Each fact table may, for example, be specific to a specific campaign and use warehouse attributes and interaction attributes relevant to that campaign. In other embodiments, a fact table may correspond to more than one campaign (e.g., up-sell and cross-sell campaigns). The fact tables may be stored in a memory such as the memory 340 shown in FIG. 3.

Following an interaction of a customer 125 of FIG. 1 with the business entity, such as a phone call made by the customer 125, a representative of the business entity responding to the phone call may employ the collateral processing system 110 of FIG. 1 to decide about offering one or more collaterals to the calling customer 125. The collateral processing system 110 may use a customer identification (e.g., a last name, an account number, a social security number, an address, and the like) provided by the customer 125 to retrieve values associated with one or more warehouse attributes corresponding to the customer 125, from the warehouse 160.

At block 270, the collateral processing system 110 may also prepare a fact query to join, the retrieved values for warehouse attributes and values of the interaction attributes resulting from the customer interaction, with the prepared fact table (e.g., fact table 700 of FIG. 7) to assign a collateral to the customer 125.

FIG. 3 is a block diagram illustrating a collateral processing system 110, according to various embodiments. The collateral processing system 110 may comprise a communication module 310, a user interface module 320 a processor 330, a memory 340, a database server 350, and a database 360. For the embodiments described herein, the user interface module 320 may interact with the display unit 810 shown in FIG. 8 to display various objects (e.g., user interfaces). The memory 340 may comprise and/or be part of a main memory 870 or a static memory 880, both shown in FIG. 8. The database 360 may be retained in disk drive unit 840 shown in FIG. 8. Portions of the database 360 may be retrieved by the database server 350 and stored in memory 340 for faster access.

The communication module 310 and the user interface module 320 may comprise software modules stored in memory 340, main memory 870, or the static memory 880 shown in FIG. 8 and be implemented by the processor 330 or the processor 860 shown in FIG. 8. The collateral processing system 110 may support a Web application including user interfaces displayed to the client 120 of FIG. 1, via the user interface module 320. The communication module 310 may receive from the client 120 of FIG. 1 qualifying criteria 140 of FIG. 1 that define assignment rules of a number of collaterals to one or more campaigns.

The collateral processing system 110 may generate the assignment tool 170 (e.g., a decision tree 600 shown in FIG. 6 or the fact table 700 shown in FIG. 7) based on the received assignment rules. The collateral processing system may also be used to assign a collateral to a customer (e.g., the customer 125 of FIG. 1) as discussed with respect to FIG. 2 and as will further be described below with respect to FIGS. 6 and 7.

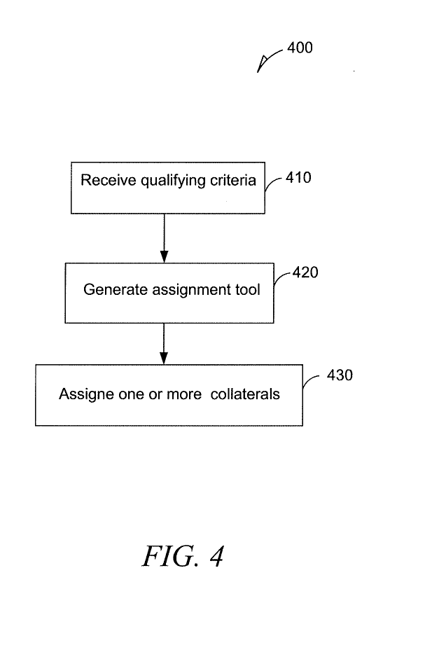

FIG. 4 is a flow diagram illustrating a method 400 of processing of collaterals, according to various embodiments. At operation 410, the communication module 310 of FIG. 3 may receive the criteria 140 over the network 150, both of FIG. 1. The criteria 140 may define selection rules for assigning collaterals to a number of campaigns. At operation 420, the collateral processing system 110 of FIG. 1 may generate an assignment tool 170 of FIG. 1 comprising a decision tree 600 shown in FIG. 6 and/or a fact table 700 shown in FIG. 7.

At operation 430, in response to a request from a user (such as a representative of a business entity) attending an interaction initiated by the customer 125 (e.g., a phone call from the customer 125), the collateral processing system 110 may assign a collateral to the customer. The collateral processing system 110 may use the decision tree 600 or the fact table 700 to process the request, as described in more detail herein.

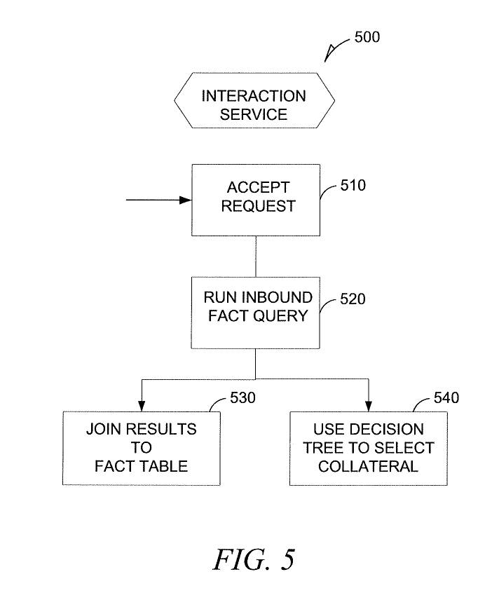

FIG. 5 is a flow diagram illustrating an interaction service 500 for servicing an inbound campaign, according to various embodiments. In an inbound campaign, one or more customers (e.g., the customer 125 of FIG. 1) may interact with a business entity, for example, to discuss service issues, inquire about new services, or make complaint. The representative of the business entity responding to the interactions may use the interaction service 500 to decide about collateral offerings to the customers. For example, the representative may report an interaction session to the interaction service 500. The report may comprise customer identification and values for one or more interaction attributes. The report may, for instance, specify that the purpose of the interaction (an interaction attribute) was a complaint or service issue (values for the interaction attribute), or that the customer 125 is interested in signing up for a new service.

The representative using the interaction service 500 may request a recommendation on the collateral offer. The interaction service 500 may comprise a software routine included in the user interface module 320 of FIG. 3. At block 510, the interaction service 500 may accept the request and in turn pass the request and the report of the interaction to the collateral processing system 110 of FIG. 1. The collateral processing system 110 may retrieve warehouse attributes for the customer 125 identified by the reported identification number. The collateral processing system 110 may also identify one or more relevant campaigns from the interaction report. For instance, if the customer 125 has called to make a complaint, then the service campaign may be a relevant campaign. In case the customer 125 has called to ask a question about a service, then the up-sell campaign and cross-sell campaigns may be appropriate. The collateral processing system 110 may further derive values for the one or more interaction attributes from the report.

At block 520, the collateral processing system 110 may prepare one or more queries to either join results (e.g., retrieved warehouse attributes and derived interaction attributes) to a fact table (block 530) such as a fact table 700 shown in FIG. 7 or use a decision tree (block 540) such as a decision tree 600 shown in FIG. 6 to assign a collateral to the customer 125.

The representative, while attending to the call initiated by the customer 125 may be able to interact with the collateral processing system 110 via the interaction service 500 in a real time manner. For instance, the representative may answer to some questions raised by the collateral processing system 110. The representative may, for example, see the questions, recommendations, and assigned collaterals by the collateral processing system 110, on a user interface. This may enable the representative to offer the assigned collateral to the customer 125 while the interaction is in session. The representative may also be able to handle multiple customer interactions and use the system 500 to offer collaterals to a number of customers at the same time.

FIG. 6 is a block diagram illustrating a decision tree 600 used for servicing an inbound campaign, according to various embodiments. A content of a report from a representative of the business entity attending to an interaction initiated by the customer 125 of FIG. 1, may indicate one or more campaigns as being relevant to the interaction. The collateral processing system 110 of FIG. 1 may decide, based the relevant campaigns to use one or more decision trees corresponding to the relevant campaigns. For example, when the business entity is a wireless service-provider company and the interaction initiated by the customer 125 is a phone call, the collateral processing system 110 may use the previously generated decision tree 600 to assign one or more collaterals to the customer 125.

The decision tree 600 starts at block 610, where years of service of the customer 125 (e.g., a warehouse attribute) is retrieved from the database 360 of FIG. 3. If the customer 125 has been with the company for 3 years, the control is passed to the decision block 620. Otherwise, if the value of years of service is determined to be one year, the control is passed to a decision block 630. In example embodiments, the decision tree 600 may provide options for other values for the years of service as well. At decision block 620 it is determined whether the purpose of the phone call was a complaint and if the answer is yes, then a phone upgrade collateral 625 is assigned to the customer 125. Here, the purpose of the call is an interaction attribute and its value of “complaint” is derived from the interaction (e.g. the call).

The decision block 630 couples to branches through the decision blocks 640 and 650, which eventually lead to collaterals 642 (free one month of service and text messaging offer), 644 (free one quarter of service and text messaging offer), 652 (free one month of service), and 654 (free one month of service and data service offer). For example, if the purpose of the call is complaint and the customer 125 is currently signed up with a text messaging plan (decision block 640) the collateral 642 is assigned to the customer 125. The assignment collaterals 652 and 654, based on values of interaction attributes, can be readily performed using the decision tree 600 and will not be further discussed here. In an embodiment discussed below, the collateral processing system 110 may use a fact table to assign collaterals to the customer 125.

FIG. 7 is block diagram illustrating a fact table 700 used for servicing an inbound campaign, according to various embodiments. The fact table 700 may be used to assign one or more of the collaterals 642, 625, and 644 shown in collateral column 710 to the customer 125 of FIG. 1. The fact table 700 includes a warehouse attribute (years of service) in column 720 for which the values of 1 or 3 are retrieved from the database 360 of FIG. 3. The corresponding values for the interaction attributes 730 (purpose of call) and 740 (current texting plan) may be derived from the customer interaction as discussed above with respect to the decision tree 600.

The collateral processing system 110 may prepare queries to join the warehouse attribute 720 and the interaction attributes 730 and 740 with the fact table 700 to assign one or more collaterals such as the collaterals 642, 644, and 625 to the customer 125. Responses to such queries may lead to assignment of collaterals in a short time (e.g., in the order of milliseconds). A representative of the business entity (e.g., the wireless service provider) attending the customer call may be able to see the assigned one or more collaterals on a user interface and offer the one or more collaterals to the calling customer (e.g., the customer 125) while the customer is on the phone. This is a distinct benefit of the present technology that allows the representative to have a decision on the selection of the collateral to be offered to the customer 125, based on a prepared fact table (e.g., fact table 600). Traditionally such decisions may involve joining multiple databases.

FIG. 8 is a block diagram of a machine 800, according to various embodiments. The machine 800 may comprise a set of instructions that can be executed to cause the machine 800 to perform any one or more of the methodologies discussed herein. In alternative embodiments, the machine 800 may operate as a standalone device or may be connected (e.g., networked) to other systems. In a networked deployment, the machine 800 may operate in the capacity of a server or a client system in a server-client network environment or as a peer system in a peer-to-peer (or distributed) network environment. Machine 800 may be realized as a specific machine in the form of a computer, comprising a system similar to or identical to the collateral processing system 110 of FIG. 3. Further, any of the elements of machine 800 (e.g., the processor 860 or the memory 870, among others) may include modules of the collateral processing system 110.

The machine 800 may comprise a server computer, a client computer, a personal computer (PC), a tablet PC, an integrated circuit, an asynchronous FPGA, or any system capable of executing a set of instructions (sequential or otherwise) that specify actions to be taken by that system. Further, while only a single machine is illustrated, the term “machine” shall also be taken to include any collection of systems that individually or jointly execute a set (or multiple sets) of instructions to perform any one or more of the methodologies discussed herein. In an embodiment, the machine 800 may operate as the collateral processing system 110 of FIG. 3 or as a client machine 130 including a client application developed based on the forgoing methods such as method 400 of FIG. 4.

The example machine 800 may include a processor 860 (e.g., a central processing unit (CPU), a graphics processing unit (GPU) or both), a main memory 870 and a static memory 880, all of which communicate with each other via a bus 808. The machine 800 may further include a display unit 810 (e.g., a liquid crystal display (LCD) or cathode ray tube (CRT)). The machine 800 also may include an alphanumeric input device 820 (e.g., a keyboard), a cursor control device 830 (e.g., a mouse), a disk drive unit 840, a signal generation device 850 (e.g., a speaker), and a network interface device 890.

The disk drive unit 840 may include a machine-readable medium 822 on which may be stored one or more sets of instructions (e.g., software) 824 embodying any one or more of the methodologies or functions described herein. The instructions 824 may also reside, completely or at least partially, within the main memory 870 and/or within the processor 860 during execution thereof by the machine 800, with the main memory 870 and the processor 860 also constituting machine-readable media. The instructions 824 may further be transmitted or received over a network 882 via the network interface device 890.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any one or more of the methodologies of the present technology. The term “machine-readable medium” shall accordingly be taken to include, but not be limited to, tangible media, including solid-state memories and optical and magnetic media.

Various embodiments related to methods and systems for processing of collaterals have been described. The embodiments may enable a representative of a business entity to offer a collateral to a customer while the customer is in an interactive session with the representative. Although example embodiments have been described, it will be evident, after reading this disclosure that various modifications and changes may be made to these embodiments. Accordingly, the specification and drawings are to be regarded in an illustrative rather than a restrictive sense.

The abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A processor-implemented method comprising:
receiving qualifying criteria from a client, the qualifying criteria defining assignments of one or more collaterals;
generating an assignment tool based on the qualifying criteria, the assignment tool including at least one stored attribute and at least one interaction attribute to be determined based on a customer interaction; and
assigning a collateral to a customer using the assignment tool.

2. The processor-implemented method of claim 1, wherein the client comprises an agent of an entity and the customer comprises the entity's customer.

3. The processor-implemented method of claim 1, wherein the defining of assignments comprise defining the assignment of the one or more collateral to one or more categories.

4. The processor-implemented method of claim 3, wherein the one or more categories comprise one or more campaigns including at least one of, a service campaign, a retention campaign, an up-sell campaign, or a cross-sell campaign.

5. The processor-implemented method of claim 1, wherein the at least one stored attribute comprises at least one warehouse attribute value corresponding to each customer.

6. The processor-implemented method of claim 1, wherein assigning the collateral comprises assigning at least one of a promotional offer, an advertisement material, or an informational material.

7. The processor-implemented method of claim 1, further comprising identifying a customer interaction.

8. The processor-implemented method of claim 7, wherein the customer interaction comprises at least one of a phone call, a text message, an email, an online chat session, a Web blog, or a social network communication.

9. The processor-implemented method of claim 7, further including deriving an interaction attribute value for the at least one interaction attribute, based on the identified interaction.

10. The processor-implemented method of claim 9, wherein the generating of the assignment tool comprises generating of a decision tree, and wherein the collateral is assigned to the customer by applying the interaction attribute value and warehouse attribute values to the decision tree.

11. The processor-implemented method of claim 9, wherein the generating of the assignment tool comprises generating a fact table, and wherein the collateral is assigned to the customer by querying the fact table using the interaction attribute value and warehouse attribute values.

12. A processor-implemented method comprising:
defining a plurality of qualifying criteria; and
using an assignment tool to assign a collateral to a customer, the assignment tool being based on the qualifying criteria, and including at least one stored attribute and at least one interaction attribute to be determined based on a customer interaction.

13. The processor-implemented method of claim 12, wherein the using of the assignment tool comprises using a decision tree, and wherein the collateral is assigned to the customer by applying interaction attribute values and warehouse attribute values to the decision tree.

14. The processor-implemented method of claim 12, the using of the assignment tool comprises using a fact table, and wherein the collateral is assigned to the customer by querying the fact table using interaction attribute values and warehouse attribute values.

15. A system comprising:
memory to retain a database and a number of modules; and
one or more processors coupled to the memory to execute the modules including:
a communication module to receive qualifying criteria from a client, the qualifying criteria defining assignments of one or more collaterals;
a tool generator module to generate an assignment tool based on the qualifying criteria, the assignment tool including at least one stored attribute and at least one interaction attribute to be determined based on a customer interaction; and
a service module to assign a collateral to a customer using the assignment tool.

16. The system of claim 15, wherein the communication module is to identify a customer interaction comprising at least one of a phone call, a text message, an email, an online chat session, a Web blog, or a social network communication.

17. The system of claim 16, wherein the service module is to derive an interaction attribute value for the at least one interaction attribute, based on the identified interaction.

18. The system of claim 17, wherein the tool generator is to generate a decision tree, and wherein the service module is to assign the collateral to the customer by applying the interaction attribute value and warehouse attribute values to the decision tree.

19. The system of claim 17, wherein the tool generator is to generate a fact table, and wherein the service module is to assign the collateral to the customer by querying the fact table using the interaction attribute value and warehouse attribute values.

20. A machine-readable medium comprising instructions, which when executed by one or more processors, perform a method comprising:
receiving qualifying criteria from a client, the qualifying criteria defining assignments of one or more collaterals;
generating an assignment tool based on the qualifying criteria, the assignment tool including at least one stored attribute and at least one interaction attribute to be determined based on a customer interaction; and
assigning a collateral to a customer using the assignment tool.

21. A machine-readable medium comprising instructions, which when executed by one or more processors, perform a method comprising:
defining a plurality of qualifying criteria; and
using an assignment tool to assign a collateral to a customer, the assignment tool being based on the qualifying criteria, and including at least one stored attribute and at least one interaction attribute to be determined based on a customer interaction.
